(19) United States
(12) Patent Application Publication
(10) Pub. No.: US 2025/0232586 A1
(43) Pub. Date: Jul. 17, 2025

(54) METHODS AND APPARATUSES FOR DETERMINING SIMILARITY BETWEEN TEXT AND VIDEO

(71) Applicant: Alipay (Hangzhou) Information Technology Co., Ltd., Hangzhou (CN)

(72) Inventors: Xuzheng Yu, Hangzhou (CN); Chen Jiang, Hangzhou (CN); Hong Liu, Hangzhou (CN); Qingpei Guo, Hangzhou (CN)

(73) Assignee: Alipay (Hangzhou) Information Technology Co., Ltd., Hangzhou (CN)

(21) Appl. No.: 19/017,116

(22) Filed: Jan. 10, 2025

(30) Foreign Application Priority Data
Jan. 11, 2024 (CN) 202410044723.5

(51) Int. Cl. G06V 20/40; G06F 40/211

(52) U.S. Cl. CPC G06V 20/46; G06F 40/211; G06V 20/41

(57) ABSTRACT

Methods and apparatuses for determining a similarity between text and a video are described. In an example, an initial text feature and an initial video feature that correspond to text and a video are respectively obtained by using a text feature extraction model and a video feature extraction model. The initial text feature is processed based on a syntactic level analysis result of the text, to obtain text features that correspond to elements in the syntactic level analysis result. A video level analysis result corresponding to the syntactic level analysis result is constructed based on a degree of matching between the text features and the initial video feature. Video features corresponding to elements in the video level analysis result are obtained. A similarity between the text and the video is determined based on a similarity between a text feature and a video feature corresponding to elements in a corresponding level.

### TECHNICAL FIELD

One or more embodiments of this specification usually relate to the field of computer technologies, and in particular, to methods for determining a similarity between text and a video, text-video retrieval methods, video-text retrieval methods, and methods and apparatuses for training a feature extraction model.

### BACKGROUND

With rapid development of Internet technologies, sizes of network videos are increasingly large, and a need for accurate calculation of semantic a similarity between text and a video in tasks such as text-video retrieval task or video-text retrieval becomes stronger. A related way is to follow a generalized paradigm, where the paradigm can usually be divided into three modules: text encoding, video encoding, and text-video alignment. A textual modality and a video modality are two modalities with different properties, where text usually has a good grammatical syntactic structure, while video data is unstructured and accompanied by a large amount of redundant information. Therefore, how to model cross-modality similarity through an alignment module to enhance a representation capability of an obtained multi-modality feature remains a very challenging and important problem.

### SUMMARY

In view of the above, one or more embodiments of this specification provide methods for determining a similarity between text and a video, text-video retrieval methods, video-text retrieval methods, and methods and apparatuses for training a feature extraction model The methods and the apparatuses can be used to improve a representation capability of a cross-modality feature, thereby further helping implement accurate calculation of a semantic similarity between text and a video.

According to an aspect of embodiments of this specification, a method for determining a similarity between text and a video is provided, including: respectively providing text and a video that are included in an acquired text-video pair for a text feature extraction model and a video feature extraction model, to obtain a corresponding initial text feature and a corresponding initial video feature, where the initial text feature includes word character features corresponding to word characters included in the text, and the initial video feature includes an image feature extracted based on an image included in the video; performing syntactic analysis on the text, to obtain a syntactic level analysis result; processing the initial text feature based on the syntactic level analysis result, to obtain text features respectively corresponding to elements in the syntactic level analysis result; constructing, based on a degree of matching between the obtained text features respectively corresponding to the elements in the syntactic level analysis result and the obtained initial video feature, a video level analysis result corresponding to the syntactic level analysis result; processing, based on the video level analysis result, initial video features corresponding to elements in the video level analysis result, to obtain video features respectively corresponding to the elements in the video level analysis result; and determining a similarity between the text and the video based on a similarity between a text feature and a video feature that respectively correspond to elements in a corresponding level.

According to another aspect of embodiments of this specification, a text-video retrieval method is provided, including: receiving query text provided by a user; determining, based on the above-mentioned method for determining a similarity between text and a video, a similarity between the query text and a candidate video that are included in each query text-video pair, where each query text-video pair is obtained based on the query text and each candidate video in a candidate video set; determining, from the candidate video set based on the determined similarity, a matching video as a video search result; and providing the video search result for the user.

According to another aspect of embodiments of this specification, a text-video retrieval method is provided, including: receiving a query video provided by a user; determining, based on the above-mentioned method for determining a similarity between text and a video, a similarity between the query video and candidate text that are included in each query text-video pair, where each query text-video pair is obtained based on the query video and each piece of candidate text in a candidate text set; determining, from the candidate text set based on the determined similarity, matching text as a text search result; and providing the text search result for the user.

According to another aspect of embodiments of this specification, a method for training a feature extraction model is provided, where the feature extraction model includes a text feature extraction model, a video feature extraction model, a text feature processing model, and a video feature processing model; and the method includes: performing, by using a training sample set, iterative execution on the following model training process until a training end condition is satisfied, where each training sample in the training sample set includes a positive example text-video pair including text data and video data that match each other or a negative example text-video pair including text data and video data that do not match each other: providing text data of each current training sample in a current training sample set for a current text feature extraction model, to obtain an initial text feature of each current training sample; providing video data of each current training sample for a current video feature extraction model, to obtain an initial video feature of each current training sample; for each current training sample, performing syntactic analysis on the text data of the current training sample, to obtain a corresponding syntactic level analysis result; providing the obtained syntactic level analysis result and the initial text feature for a current text feature processing model, to obtain text features respectively corresponding to elements in the syntactic level analysis result; constructing, based on a degree of matching between the obtained text features respectively corresponding to the elements in the syntactic level analysis result and the obtained initial video feature, a video level analysis result corresponding to the syntactic level analysis result; providing, based on the video level analysis result, initial video features corresponding to elements in the video level analysis result for a current video feature processing model, to obtain video features respectively corresponding to the elements in the video level analysis result; and determining a similarity between the text data of the current training sample and corresponding video data based on a similarity between a text feature and a video feature that respectively correspond to elements in a corresponding level; determining, based on a determined similarity between the text data of each current training sample and corresponding video data, a contrastive loss value corresponding to the current training sample set; and adjusting a model parameter of a current feature extraction model based on the contrastive loss value in response to dissatisfaction of the training end condition, where the feature extraction model after being adjusted by using the model parameter is used as a current feature extraction model for a next model training process.

According to another aspect of embodiments of this specification, an apparatus for determining a similarity between text and a video is provided, including: a feature extraction unit, configured to respectively provide text and a video that are included in an acquired text-video pair for a text feature extraction model and a video feature extraction model, to obtain a corresponding initial text feature and a corresponding initial video feature, where the initial text feature includes word character features corresponding to word characters included in the text, and the initial video feature includes an image feature extracted based on an image included in the video; a level analysis unit, configured to perform syntactic analysis on the text, to obtain a syntactic level analysis result; and construct, based on a degree of matching between the obtained text features respectively corresponding to the elements in the syntactic level analysis result and the obtained initial video feature, a video level analysis result corresponding to the syntactic level analysis result; a text feature processing unit, configured to process the initial text feature based on the syntactic level analysis result, to obtain the text features respectively corresponding to the elements in the syntactic level analysis result; a video feature processing unit, configured to process, based on the video level analysis result, initial video features corresponding to elements in the video level analysis result, to obtain video features respectively corresponding to the elements in the video level analysis result; and a similarity determining unit, configured to determine a similarity between the text and the video based on a similarity between a text feature and a video feature that respectively correspond to elements in a corresponding level.

According to another aspect of embodiments of this specification, a text-video retrieval apparatus is provided, including: a text receiving unit, configured to receive query text provided by a user; a similarity calculation unit, configured to determine, based on the above-mentioned method for determining a similarity between text and a video, a similarity between the query text and a candidate video that are included in each query text-video pair, where each query text-video pair is obtained based on the query text and each candidate video in a candidate video set; and a video result providing unit, configured to determine, from the candidate video set based on the determined similarity, a matching video as a video search result; and provide the video search result for the user.

According to another aspect of embodiments of this specification, a video-text retrieval apparatus is provided, including: a video receiving unit, configured to receive a query video provided by a user; a similarity calculation unit, configured to determine, based on the above-mentioned method for determining a similarity between text and a video, a similarity between the query video and candidate text that are included in each query text-video pair, where each query text-video pair is obtained based on the query video and each piece of candidate text in a candidate text set; and a text result providing unit, configured to determine, from the candidate text set based on the determined similarity, matching text as a text search result; and provide the text search result for the user.

According to another aspect of embodiments of this specification, an apparatus for training a feature extraction model is provided, where the feature extraction model includes a text feature extraction model, a video feature extraction model, a text feature processing model, and a video feature processing model; and the apparatus is configured to perform, through a training unit by using a training sample set, iterative execution on a model training process until a training end condition is satisfied, where each training sample in the training sample set includes a positive example text-video pair including text data and video data that match each other or a negative example text-video pair including text data and video data that do not match each other, and the training unit includes: a feature extraction module, configured to provide text data of each current training sample in a current training sample set for a current text feature extraction model, to obtain an initial text feature of each current training sample; and provide video data of each current training sample for a current video feature extraction model, to obtain an initial video feature of each current training sample; a level analysis module, configured to perform syntactic analysis on the text data of each current training sample, to obtain a corresponding syntactic level analysis result; and construct, based on a degree of matching between obtained text features respectively corresponding to elements in the syntactic level analysis result and the obtained initial video feature, a video level analysis result corresponding to each syntactic level analysis result; a text feature processing module, configured to provide the obtained syntactic level analysis result and the initial text feature for a current text feature processing model, to obtain text features respectively corresponding to elements in each syntactic level analysis result; a video feature processing module, configured to provide, based on the video level analysis result, initial video features corresponding to elements in the video level analysis result for a current video feature processing model, to obtain video features respectively corresponding to elements in each video level analysis result; a similarity determining module, configured to determine a similarity between the text data of each current training sample and corresponding video data based on a similarity between a text feature and a video feature that respectively correspond to elements in a corresponding level; and a loss value determining module, configured to determine, based on a determined similarity between the text data of each current training sample and corresponding video data, a contrastive loss value corresponding to the current training sample set. The apparatus further includes: a parameter adjustment unit, configured to adjust a model parameter of a current feature extraction model based on the contrastive loss value in response to dissatisfaction of the training end condition, where the feature extraction model after being adjusted by using the model parameter is used as a current feature extraction model for a next model training process.

According to another aspect of embodiments of this specification, an apparatus for determining a similarity between text and a video is provided, including at least one processor and a storage coupled to the at least one processor, where the storage stores an instruction. When the instruction is executed by the at least one processor, the at least one processor is enabled to perform the above-mentioned method for determining a similarity between text and a video.

According to another aspect of embodiments of this specification, a text-video matching retrieval apparatus is provided, including at least one processor and a storage coupled to the at least one processor, where the storage stores an instruction. When the instruction is executed by the at least one processor, the at least one processor is enabled to perform the above-mentioned text-video retrieval method or video-text retrieval method.

According to another aspect of embodiments of this specification, an apparatus for training a feature extraction model is provided, including at least one processor and a storage coupled to the at least one processor, where the storage stores an instruction. When the instruction is executed by the at least one processor, the at least one processor is enabled to perform the above-mentioned method for training a feature extraction model.

According to another aspect of embodiments of this specification, a computer-readable storage medium is provided, where the computer-readable storage medium stores a computer program. When the computer program is executed by a processor, the above-mentioned method for determining a similarity between text and a video, text-video retrieval method, video-text retrieval method, and/or method for training a feature extraction model are/is implemented.

According to another aspect of embodiments of this specification, a computer program product is provided, including a computer program. The computer program is executed by a processor, to implement the above-mentioned method for determining a similarity between text and a video, text-video retrieval method, video-text retrieval method, and/or method for training a feature extraction model.

### BRIEF DESCRIPTION OF DRAWINGS

The essence and advantages of the content of this specification can be further understood by referring to the following accompanying drawings. In the accompanying drawings, similar components or features can have the same reference numerals.

FIG. 1 shows an example architecture of a method for determining a similarity between text and a video, a text-video retrieval method, a video-text retrieval method, and a method and an apparatus for training a feature extraction model, according to one or more embodiments of this specification;

FIG. 2 is an example flowchart illustrating a method for determining a similarity between text and a video, according to one or more embodiments of this specification;

FIG. 3 is an example flowchart illustrating a text feature determining process, according to one or more embodiments of this specification;

FIG. 4 is an example diagram illustrating a video level analysis result, according to one or more embodiments of this specification;

FIG. 5 is an example flowchart illustrating a video level analysis result construction process, according to one or more embodiments of this specification;

FIG. 6 is another example flowchart illustrating a video level analysis result construction process, according to one or more embodiments of this specification;

FIG. 7 is an example flowchart illustrating a determining process of video features respectively corresponding to elements in a video level analysis result, according to one or more embodiments of this specification;

FIG. 8 is an example diagram illustrating a determining process of a similarity between text and a video, according to one or more embodiments of this specification;

FIG. 9 is an example flowchart illustrating a text-video retrieval method, according to one or more embodiments of this specification;

FIG. 10 is an example flowchart illustrating a video-text retrieval method, according to one or more embodiments of this specification;

FIG. 11 is an example flowchart illustrating a method for training a feature extraction model, according to one or more embodiments of this specification;

FIG. 12 is an example block diagram illustrating an apparatus for determining a similarity between text and a video, according to one or more embodiments of this specification;

FIG. 13 is an example block diagram illustrating a text-video retrieval apparatus, according to one or more embodiments of this specification;

FIG. 14 is an example block diagram illustrating a video-text retrieval apparatus, according to one or more embodiments of this specification;

FIG. 15 is an example block diagram illustrating an apparatus for training a feature extraction model, according to one or more embodiments of this specification;

FIG. 16 is an example block diagram illustrating an apparatus for determining a similarity between text and a video, according to one or more embodiments of this specification;

FIG. 17 is an example block diagram illustrating a text-video matching retrieval apparatus, according to one or more embodiments of this specification; and

FIG. 18 is an example block diagram illustrating an apparatus for training a feature extraction model, according to one or more embodiments of this specification.

### DESCRIPTION OF EMBODIMENTS

The subject matter described in this specification is discussed below with reference to example implementations. It should be understood that these implementations are merely discussed to enable a person skilled in the art to better understand and implement the subject matter described in this specification, and are not intended to limit the protection scope, applicability, or examples described in the claims. The functions and arrangements of the elements under discussion can be changed without departing from the protection scope of the embodiment content of this specification. Various processes or components can be omitted, replaced, or added in the examples as needed. In addition, features described for some examples can also be combined in other examples.

As used in this specification, the term “include” and a variant thereof represent open terms, meaning “including but not limited to”. The term “based on” means “at least partially based on”. The terms “one embodiment” and “one or more embodiments” represent “at least one embodiment”. The term “another embodiment” represents “at least one other embodiment”. The terms “first”, “second”, etc. can refer to different or identical objects. Other definitions, whether explicit or implicit, can be included below. Unless expressly specified in the context, the definition of a term is consistent throughout this specification.

In this specification, the term “contrastive loss” is widely used in unsupervised learning. The loss function is mainly used in a process of dimension reduction (for example, feature extraction). To be specific, originally similar samples are still similar in feature space after dimension reduction of the two samples; and originally dissimilar samples are still dissimilar in the feature space after dimension reduction of the two samples. Therefore, the loss function can also well represent a degree of matching between samples in a pair.

A method for determining a similarity between text and a video, a text-video retrieval method, a video-text retrieval method, and a method and an apparatus for training a feature extraction model according to one or more embodiments of this specification are described in detail below with reference to the accompanying drawings.

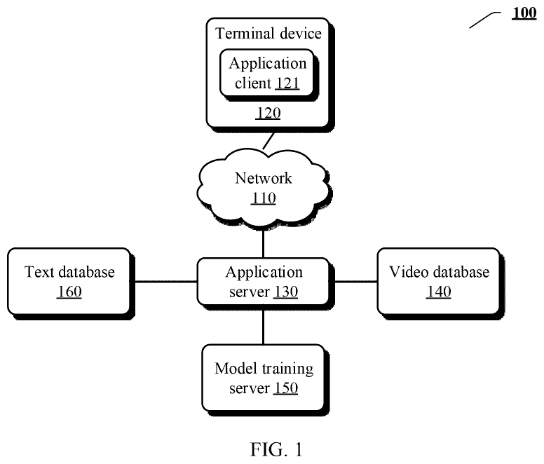

FIG. 1 is an example architecture 100 of a method for determining a similarity between text and a video, a text-video retrieval method, a video-text retrieval method, and a method and an apparatus for training a feature extraction model, according to one or more embodiments of this specification.

In FIG. 1, a network 110 is applied to interconnect between a terminal device 120 and an application server 130.

The network 110 can be any type of network that can interconnect network entities. The network 110 can be a single network or a combination of various networks. In terms of coverage, the network 110 can be a local area network (LAN), a wide area network (WAN), etc. In a bearing medium aspect, the network 110 can be a wired network, a wireless network, etc. In terms of data switching technologies, the network 110 can be a circuit switching network, a packet switching network, etc.

The terminal device 120 can be any type of electronic computing device that can connect to the network 110, access a server or website on the network 110, process data or a signal, etc. For example, the terminal device 120 can be a desktop computer, a laptop computer, a tablet computer, a smartphone, etc. Although only one terminal device is shown in FIG. 1, it should be understood that different quantities of terminal devices can be connected to the network 110. In an implementation, the terminal device 120 can be used by a user. The terminal device 120 can include an application client (such as an application client 121) that provides various services for the user. In some cases, the application client 121 can interact with the application server 130. For example, the application client 121 can transmit a message entered by the user to the application server 130 and receive a response associated with the message from the application server 130. In this specification, “message” can refer to any input information, such as query text or a query video from a user input.

The application server 130 can store a feature extraction model for determining a similarity between text and a video. The feature extraction model can include a text feature extraction model, a video feature extraction model, a text feature processing model, and a video feature processing model. The application server 130 can be connected to a video database 140. The video database 140 can include each candidate video. The application server 130 can be further connected to a model training server 150. The model training server 150 can be used for training, to obtain the above-mentioned text feature extraction model, video feature extraction model, text feature processing model, and video feature processing model. The application server 130 can be further connected to a text database 160. The text database 160 can include each piece of candidate text. Therefore, the application server 130 can also correspondingly provide a video-text retrieval service. However, it should be understood that, in other cases, the application server 130 can alternatively locally store a candidate video or candidate text and perform training, to obtain the above-mentioned text feature extraction model, video feature extraction model, text feature processing model, and video feature processing model, instead of interacting with the video database 140, the model training server 150, and the text database 160.

It should be understood that all network entities shown in FIG. 1 are examples. According to a specific application need, the architecture 100 can include any other network entity.

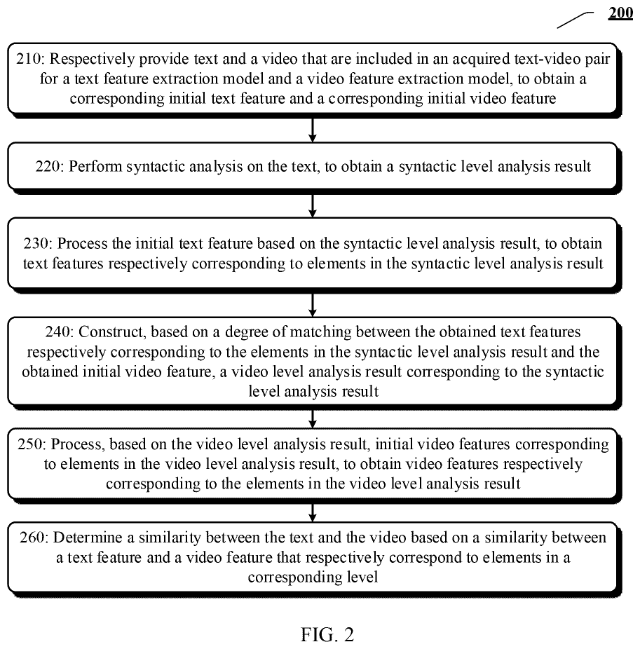

FIG. 2 is a flowchart illustrating a method 200 for determining a similarity between text and a video, according to one or more embodiments of this specification.

As shown in FIG. 2, in 210, text and a video that are included in an acquired text-video pair are respectively provided for a text feature extraction model and a video feature extraction model, to obtain a corresponding initial text feature and a corresponding initial video feature.

In this embodiment, the text feature extraction model and the video feature extraction model can be high-dimensional feature models that are used to generate text and a video and that are obtained through training based on a feature extraction backbone model. In an example, the feature extraction backbone model can include but is not limited to at least one of the following: a transformer model, a ViT (vision transformer) model, a BERT (Bidirectional Encoder Representations from Transformers) model, a generative pre-training (Generative Pre-Training, GPT) model, a CLIP model, and a convolutional neural network (Convolutional Neural Networks, CNN).

In this embodiment, the text feature extraction model can be used to obtain, as the initial text feature based on text, word character features corresponding to word characters included in the text. In an example, if the text includes Nₜ words, the text feature can be represented, for example, as F^{t}[f₁^{t}, f₂^{t}, f₃^{t}, . . . , f_{N}_{ₜ}^{t}]∈ [symbol] . D can refer to a length of each feature (for example, f₁^{t}, f₂^{t}, . . . ). In an example, the initial text feature can further include a global text feature corresponding to a word character (for example, a [CLS] word character) used to represent an entire sentence of the text, and can be represented, for example, by f_{cls}^{t}.

The video feature extraction model can be used to obtain, as the initial video feature based on an image included in the video, a corresponding image feature sequence. In an example, Nᵥ video frames can be obtained by first performing extraction on the video based on a sampling rate (for example, one frame per second) or a key frame extraction technique, and then image features corresponding to the video frames can be obtained through the video feature extraction model. For example, the initial video feature can be represented as F^{v}=[F₁^{v}, F₂^{v}, F₃^{v}, . . . , f_{N}_{ᵥ}^{v}]∈ [symbol] [symbol] . D can refer to a length of each feature (for example, F₁^{v}, F₂^{v}, F₃^{v}, . . . ). Fᵢ^{v} can be used to represent an initial video feature corresponding to an i^{th} video frame. In an example, the i^{th} video frame can alternatively be first divided into Nₚ image patches, and then an image patch feature corresponding to each image patch can be obtained through the video feature extraction model. For example, Fᵢ^{v} can be further represented as Fᵢ^{v}=[f_{i,1}^{v}, f_{i,2}^{v}, f_{i,3}^{v}, . . . , f_{i,N}_{ₚ}^{v}]. f_{i,j}^{v} can be used to represent an image patch feature, to be specific, a local image feature of a frame level, corresponding to a j^{th} image patch in the i^{th} video frame. In an example, Fᵢ^{v} can alternatively be used to represent a frame feature, to be specific, a global feature f_{i,cls}^{v} of a frame level, corresponding to the i^{th} video frame. In an example, Fᵢ^{v} can further include the above-mentioned two, to be specific, Fᵢ^{v}=[f_{i,cls}^{v}, f_{i,1}^{v}, f_{i,2}^{v}, f_{i,3}^{v}, . . . , f_{i,N}_{ₚ}^{v}]. For a meaning of a related symbol, references can be made to the above.

In 220, syntactic analysis is performed on the text, to obtain a syntactic level analysis result.

In this embodiment, various syntactic analysis tools can be used to obtain a word class tag for each word included in the text and a syntactic dependency relationship between words. The syntactic analysis tools can include, for example, spacy, NLTK, Stanford CoreNLP, and Stanza. Afterwards, a syntactic tree can be constructed based on the syntactic dependency relationship, and then the syntactic tree can be analyzed, by using search algorithms such as depth-first, into a syntactic level structure that has a specified level, to be specific, the syntactic level analysis result is obtained. In an example, the syntactic level analysis result can be a result obtained by extracting, by following a global-to-local structure, subject information from the text.

Optionally, elements in the syntactic level analysis result can include: a sentence node (which can be represented, for example, by h₁^{t1}) located at a first level (which can be represented, for example, by H¹) and an action node (which can be represented, for example, by h₁^{t2}, h₂^{t2}, h₃^{t2}) located at a second level (which can be represented, for example, by H²). In an example, the sentence node can be used to indicate the text as a whole. In an example, the action node can correspond to each verb in the text. In an example, each action node can be connected to the sentence node.

Optionally, the elements in the syntactic level analysis result can further include an entity node (which can be represented, for example, by h₁^{t3}, h₂^{t3}, h₃^{t3}) located at a third level (which can be represented, for example, by H³). In an example, the entity node can correspond to words, such as nouns and pronouns related to verbs indicated by the action node, that indicate entities. In an example, each action node can be connected to an entity node associated with the action node for representing a constructed action phrase (for example, of a subject-predicate structure, a subject-predicate-object structure, and a verb-object structure).

Optionally, the elements in the syntactic level analysis result can further include an attribute node (which can be represented, for example, by h₁^{t4}, h₂^{t4}, h₃^{t4}) located at a fourth level (which can be represented, for example, by H⁴). In an example, the attribute node can correspond to modifiers used to modify the entity node. The modifiers can be, for example, adjectives. In an example, each attribute node can be connected to an entity node associated with the attribute node.

In 230, the initial text feature is processed based on the syntactic level analysis result, to obtain text features respectively corresponding to the elements in the syntactic level analysis result.

In this embodiment, the text features respectively corresponding to the elements in the syntactic level analysis result can be determined based on the obtained word character features corresponding to the word characters. In an example, the global text feature f_{cls}^{t} can be determined as a text feature corresponding to the sentence node located at the first level. In an example, a word character feature corresponding to the verb included in the text can be determined as a text feature corresponding to the corresponding action node located at the second level. Similarly, text features corresponding to each entity node and each attribute node that are located at the third level and the fourth level can be respectively obtained.

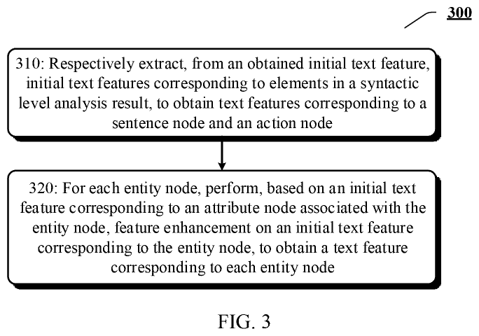

Optionally, refer to FIG. 3. FIG. 3 is an example flowchart illustrating a text feature determining process 300, according to one or more embodiments of this specification.

As shown in FIG. 3, in 310, initial text features corresponding to elements in a syntactic level analysis result are respectively extracted from an obtained initial text feature, to obtain text features corresponding to a sentence node and an action node.

In an example, for obtaining the text features corresponding to the sentence node and the action node, references can be made to the above.

In 320, for each entity node, feature enhancement is performed, based on an initial text feature corresponding to an attribute node associated with the entity node, on an initial text feature corresponding to the entity node, to obtain a text feature corresponding to each entity node.

In an example, the feature enhancement can be performed based on an attention mechanism. In an example, for an i^{th} entity node (which can be represented, for example, by hᵢ^{t3}) located at the third level, a text feature fᵢ^{t3′} corresponding to the entity node can be represented as follows: fᵢ^{t3′}=eᵢ^{t3′}+fusion(eᵢ^{t3′}⊕fᵢ^{t4′}), where fᵢ^{t4′}=Σ_{j∈φ}_{ᵢ}_{³}α_{i,j}^{desc}·fⱼ^{t4},

$${a}_{i , j}^{d e s c} = \frac{exp ( match ( {e}_{i}^{t {3}^{′}} , {f}_{j}^{t 4} ) )}{{Σ}_{j ∈ {φ}_{i}^{3}} exp ( match ( {e}_{i}^{t {3}^{′}} , {f}_{j}^{t 4} ) )} ,$$

and eᵢ^{t3′}=norm(fᵢ^{t3′}+MLP₄(fᵢ^{t3′}). norm(·) can be used to represent a level normalization operation. fᵢ^{t3} can be used to represent an initial text feature (for example, a word character feature) corresponding to the i^{th} entity node located at the third level. MLP₄(·) can be used to represent a multilayer perception that can be obtained through training. match(·) can be used to represent calculation of a degree of matching between two features, and can be obtained, for example, through inner product similarity, cosine similarity, a neural network used to calculate the degree of matching, etc. or can be used to represent a set of attribute nodes that are located at a (k+1)^{th} level and that are associated with an i^{th} entity node located at a k^{th} level. fⱼ^{t4} can be used to represent an initial text feature corresponding to a j^{th} attribute node that is located at a fourth level and that is associated with the entity node hᵢ^{t3}. ⊕ can be used to represent a concatenation (concat) in a dimension direction. fusion(·) can be used to represent fusion in the dimension direction (for example, compressing a dimension from 2d to d).

Based on this, in this solution, a feature of the attribute node in the syntactic level analysis result can be fused into a feature of the entity node, so that an obtained text feature of the entity node can include richer and finer-grained information, thereby improving a feature representation capability.

Still refer to FIG. 2. In 240, a video level analysis result corresponding to the syntactic level analysis result is constructed based on a degree of matching between the obtained text features respectively corresponding to the elements in the syntactic level analysis result and the obtained initial video feature.

In this embodiment, elements in the constructed video level analysis result can match corresponding elements in corresponding levels in the syntactic level analysis result.

In an example, correspondingly, the elements in the video level analysis result can include: a video node located at a first level (which can be represented, for example, by h₁^{v1}) and a frame node located at a second level (which can be represented, for example, by h₁^{v1}, h₂^{v1}, h₃^{v1}). The frame node corresponds to a video frame group, and each video frame in the video frame group matches a corresponding action node in the syntactic level analysis result.

Correspondingly, the elements in the video level analysis result can further include an image patch node (which can be represented, for example, by h₁^{v1}, h₂^{v1}, h₃^{v1}) located at a third level. The image patch node corresponds to an image patch group, and each image patch in the image patch group matches a corresponding entity node in the syntactic level analysis result and belongs to a video frame in a corresponding video frame group.

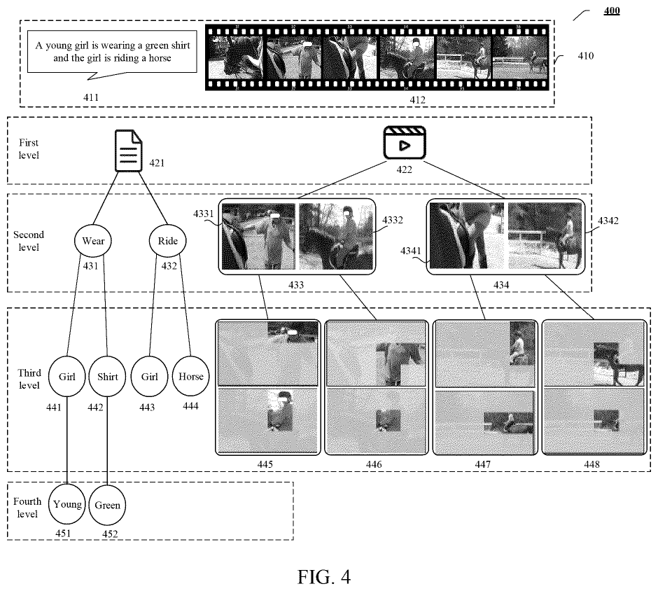

Optionally, further, refer to FIG. 4. FIG. 4 is an example diagram illustrating a video level analysis result 400, according to one or more embodiments of this specification. As shown in FIG. 4, a text pair 410 includes text 411 and a video 412. A syntactic level analysis result for the text 411 “A young girl is wearing a green shirt and the girl is riding a horse” can include a sentence node 421 located at a first level 420, action nodes 431 and 432 that are located at a second level 430, and entity nodes 441, 442, 443, and 444 that are located at a third level 440. Optionally, the syntactic level analysis result can further include attribute nodes 451 and 452 that are located at a fourth level 450. It can be understood that an association relationship between nodes of neighboring levels can be represented by a connection relationship.

Correspondingly, a video level analysis result for the video 412 can include a video node 422 located at a first level 420, frame nodes 433 and 434 that are located at a second level 430, and image patch nodes 445, 446, 447, and 448 that are located at a third level 440. The frame node 433 can be used to represent a video frame group, which can include, for example, two video frames 4331 and 4332 that embody “wear”, that matches the action node 431. Similarly, the frame node 434 can be used to represent a video frame group, which can include, for example, two video frames 4341 and 4342 that embody “ride”, that matches the action node 432. Further, the image patch node 445 can be used to represent an image patch group matching the entity node 441. The image patch group can include image patches embodying “girl” in the video frames 4331 and 4332. Similarly, an image patch group that matches the entity node 442 and that is represented by the image patch node 446 can include image patches embodying “shirt” in the video frames 4331 and 4332. An image patch group that matches the entity node 443 and that is represented by the image patch node 447 can include image patches embodying “girl” in the video frames 4341 and 4342. An image patch group that matches the entity node 444 and that is represented by the image patch node 448 can include image patches embodying “horse” in the video frames 4341 and 4342. It can be understood that an association relationship between nodes of neighboring levels can be represented by a connection relationship.

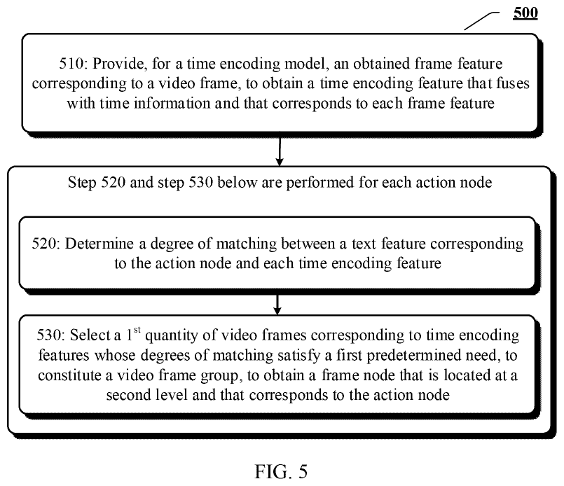

Optionally, refer to FIG. 5. FIG. 5 is an example flowchart illustrating a video level analysis result construction process 500, according to one or more embodiments of this specification.

As shown in FIG. 5, in 510, an obtained frame feature corresponding to a video frame is provided for a time encoding model, to obtain a time encoding feature that fuses with time information and that corresponds to each frame feature.

In an example, the time encoding model can, for example, be any model that fuses with sequence position information and that is based on transformer. In an example, for a frame feature f_{i,cls}^{v} corresponding to an i^{th} video frame, a time encoding feature fused with time information can be represented as gᵢ^{v}=Transformer (f_{i,cls}^{v}).

Step 520 and step 530 below can be performed for each action node.

In 520, a degree of matching is determined between a text feature corresponding to the action node and each time encoding feature.

In this embodiment, the degree of matching can be obtained, for example, through inner product similarity, cosine similarity, a neural network used to calculate the degree of matching, etc.

In an example, refer to FIG. 4. For the action node 431, degrees of matching between a text feature corresponding to the action node 431 and time encoding features corresponding to the video 410 can be respectively determined.

In 530, a 1^{st} quantity of video frames corresponding to a time encoding feature whose degree of matching satisfies a first predetermined need is selected to constitute a video frame group, to obtain a frame node that is located at a second level and that corresponds to the action node. In this embodiment, the first predetermined need can, for example, be greater than a first predetermined threshold or the first 1^{st} quantity with a highest degree of matching. In an example, a set including frame nodes that are located at the second level and that correspond to an i^{th} action node hᵢ^{t2} located at a second level can be represented as of φᵢ²=argTopKⱼ^{λ}^{₂}({match(eᵢ^{t2},gⱼ^{v})|j∈[1,Nᵥ]}), where eᵢ^{t2}=norm(fᵢ^{t2}+MLP₂(fᵢ^{t2})·argTopKⱼ^{λ}^{₂}(valⱼ) can be used to represent a set of indexes j corresponding to the first λ₂ values that are the highest in a set {valⱼ}. For a meaning of a remaining symbol, references can be made to the above.

In an example, refer to FIG. 4. For the action node 431, two frames with a highest degree of matching (for example, the video frames 4331 and 4332) can be selected to form the frame node 433 matching the action node 431. Similarly, the frame node 434 matching the action node 432 can further be formed.

Based on this, in this solution, an image frame semantically related to an action can be selected through guiding based on an action node in a syntactic level analysis result of text, thereby laying a foundation for obtaining, after feature fusion, a visual feature that is related to a specific action and that has a stronger representation capability.

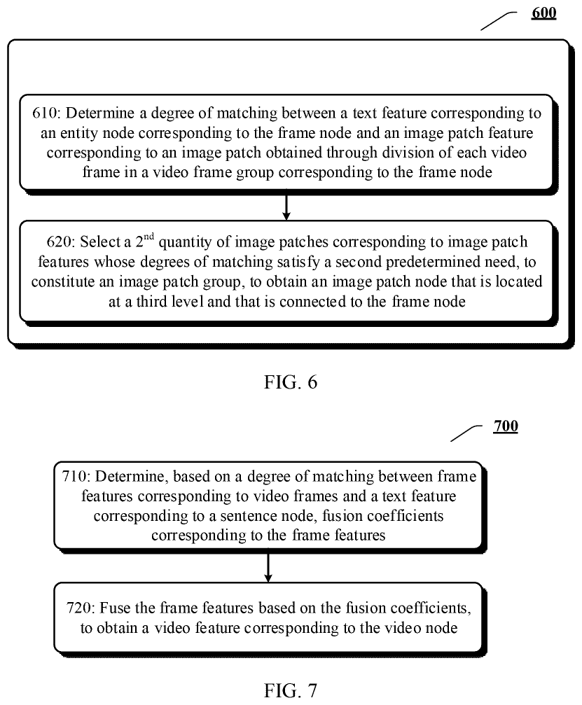

Optionally, refer to FIG. 6. FIG. 6 is another example flowchart illustrating a video level analysis result construction process 600, according to one or more embodiments of this specification.

As shown in FIG. 6, step 610 and step 620 below can be performed for each frame node.

In 610, a degree of matching is determined between a text feature corresponding to an entity node corresponding to the frame node and an image patch feature corresponding to an image patch obtained through division of each video frame in a video frame group corresponding to the frame node.

In an example, references can be made to related operations in step 520 in the above-mentioned embodiment of FIG. 5.

In an example, refer to FIG. 4. For the frame node 433, entity nodes related to the action node 431 matching the frame node 433 can include the entity node 441 and the entity node 442. For the entity node 441, degrees of matching can be respectively determined between a text feature corresponding to the entity node 441 and image patch features corresponding to image patches obtained through division of the video frames 4331 and 4332 that correspond to the frame node 433. Similarly, for the entity node 442, degrees of matching can be further respectively determined between a text feature corresponding to the entity node 442 and image patch features corresponding to image patches obtained through division of the video frames 4331 and 4332 that correspond to the frame node 433. Similarly, for the frame node 434, degrees of matching can be further respectively determined between text features corresponding to the entity nodes 443 and 444 and image patch features corresponding to image patches obtained through division of the video frames 4341 and 4342 that correspond to the frame node 433.

In 620, a 2^{nd} quantity of image patches corresponding to image patch features whose degrees of matching satisfy a second predetermined need is selected to constitute an image patch group, to obtain an image patch node that is located at a third level and that is connected to the frame node.

In this embodiment, the second predetermined need can, for example, be greater than a second predetermined threshold or the first 2^{nd} quantity with a highest degree of matching In an example, a set including image patch nodes that are located at the third level and that are connected to the frame node can be represented as φ_{i,j}³=argTopKₓ^{λ}^{₃}({match(eᵢ^{t3}, f_{j,x}^{v})|x∈[1,Nₚ]}), where eᵢ^{t3}=norm(fᵢ^{t3′}+MLP₃(fᵢ^{t3′})). φ_{i,j}³ can represent a set of image patches selected from image patches (for example, with a quantity of 3×4) obtained through division of a j^{th} frame, based on a degree of matching with a corresponding entity node hᵢ^{t3}. For a meaning of a remaining symbol, references can be made to the above.

In an example, refer to FIG. 4. For the frame node 433, image patches (for example, image patches in a column 3 and a column 4 that are of a row 1) whose degrees of matching are greater than the second predetermined threshold can be selected from the corresponding video frame 4331; and similarly, image patches (for example, image patches in columns 3 of a row 1 and a row 2) whose degrees of matching are greater than the second predetermined threshold can be selected from the corresponding video frame 4332. In this way, the image patch node 445 that is located at the third level and that is connected to the frame node 433 is formed. It can be understood that the image patch node 445 matches the entity node 441. Similarly, the image patch nodes 446, 447, and 448 respectively matching the entity nodes 442, 443, and 444 can further be formed.

Based on this, in this solution, an image patch can be selected through guiding based on entity nodes (feature-enhanced) in a syntactic level analysis result, thereby providing a technical basis for obtaining, after feature fusion, a feature representation that includes more fine-grained local information than a global feature of a video frame (for example, a classification labeling feature [CLS] of the video frame).

Still refer to FIG. 2. In 250, initial video features corresponding to the elements are processed based on the video level analysis result, to obtain video features respectively corresponding to elements in the video level analysis result.

In an example, for each element in the video level analysis result, a video feature corresponding to the element (for example, a video node, a frame node, or an image patch node) can be obtained by fusing, in various ways, initial video features corresponding to the element.

Optionally, refer to FIG. 7. FIG. 7 is an example flowchart illustrating a determining process 700 of video features respectively corresponding to elements in a video level analysis result, according to one or more embodiments of this specification.

As shown in FIG. 7, in 710, fusion coefficients corresponding to frame features corresponding to video frames are determined based on a degree of matching between the frame features and a text feature corresponding to a sentence node.

In this embodiment, the degree of matching can be obtained, for example, through inner product similarity, cosine similarity, a neural network used to calculate the degree of matching, etc. In an example, a higher degree of matching indicates a larger value of a corresponding fusion coefficient.

In an example, a fusion coefficient corresponding to a frame feature f_{i,cls}^{v} corresponding to a j^{th} video frame can be represented as

$${a}_{1 , j}^{cls} = \frac{exp ( match ( {e}_{1}^{t 1} , {f}_{j , cls}^{v} ) )}{{Σ}_{j ∈ [ 1 , {N}_{v} ]} exp ( match ( {e}_{1}^{t 1} , {f}_{j , cls}^{v} ) )} ,$$

where e₁^{t1}=norm(f₁^{t1}+MLP₁(f₁^{t1})). f₁^{t1} can be used to represent the text feature corresponding to the sentence node. For a meaning of a remaining symbol, references can be made to the above.

In 720, the frame features are fused based on the fusion coefficients, to obtain a video feature corresponding to a video node.

In this embodiment, the video feature corresponding to the video node can be obtained through weighted fusion based on the fusion coefficients. In an example, the video feature corresponding to the video node can be represented as e₁^{v1}=Σ_{j∈[1,N}_{ᵥ}_{]}α_{1,j}^{cls}. f_{j,cls}^{v}.

Based on this, in this solution, initial video features corresponding to image frames can be fused through guiding based on an overall degree of matching between text and a video, thereby obtaining a global video representation that is based on matched text (for example, query text).

Optionally, for each frame node, time encoding features corresponding to video frames in a video frame group corresponding to the frame node can be fused, to obtain a video feature corresponding to the frame node. In an example, a video feature corresponding to an i^{th} frame node located at a second level can be represented as

$${e}_{i}^{v 2} = \frac{1}{{λ}_{2}} {Σ}_{j ∈ {φ}_{i}^{2}} {g}_{j}^{v} .$$

For a meaning of a related symbol, references can be made to related descriptions of step 530 in the above-mentioned embodiment of FIG. 5. Optionally, in the above-mentioned fusion way, weighted fusion can alternatively be performed with reference to the step of determining the fusion coefficients of step 710 above.

Optionally, for each image patch node, image patch features corresponding to image patches in an image patch group corresponding to the image patch node are fused, to obtain a video feature corresponding to the image patch node. In an example, a video feature corresponding to an i^{th} image patch node located at a third level can be represented as

$${e}_{i}^{v 3} = \frac{1}{{λ}_{2}} {Σ}_{j ∈ {φ}_{{δ}_{i}^{3}}^{2}} {e}_{i , j}^{v 3} . {e}_{i , j}^{v 3} = \frac{1}{{λ}_{3}} {Σ}_{x ∈ {φ}_{i , j}^{3}} {f}_{j , x}^{v} . {δ}_{i}^{l}$$

can be used to represent a node that is located at an (l−1)^{th} level and that is associated with an i^{th} node hᵢ^{l} located at an i^{th} level. For a meaning of a related symbol, references can be made to related descriptions of step 620 in the above-mentioned embodiment of FIG. 6. Optionally, in the above-mentioned fusion way, weighted fusion can alternatively be performed with reference to the step of determining the fusion coefficients of step 710 above.

In an example, refer to FIG. 4. For the image patch node 445, image patch features corresponding to image patches, in a column 3 and a column 4 of a row 1, selected from the video frame 4331 can be fused (for example, averaging is performed), to obtain a local video feature corresponding to the video frame 4331. Similarly, image patch features corresponding to image patches, in columns 3 of a row 1 and a row 2, selected from the video frame 4332 can be fused (for example, averaging is performed), to obtain a local video feature corresponding to the video frame 4332. Then, a video feature corresponding to the image patch node 445 is obtained by fusing (for example, performing averaging on) the local video features corresponding to the video frames 4331 and 4332.

Still refer to FIG. 2, in 260, a similarity between the text and the video is determined based on a similarity between a text feature and a video feature that respectively correspond to elements in a corresponding level.

In an example, a similarity between a text feature corresponding to a sentence node and a video feature corresponding to a video node can be determined. In an example, for elements located at a second level, a similarity between a text feature of an action node and a video feature corresponding to a frame node that matches the action node can be determined. In an example, for elements located at a third level, a similarity between a text feature of an entity node and a video feature corresponding to an image patch node that matches the entity node can be determined. Afterwards, the similarity between the text and the video can be determined by fusing, in various ways, obtained similarities.

Optionally, the similarity between the text and the video can be determined by performing weighted summation on similarity between text features and video features that respectively correspond to elements in all levels.

In an example, different weights can be predetermined for different levels, and then averaging is performed on similarities obtained for the levels. In an example, different weights can be determined for elements in a level structure based on an attention mechanism, thereby determining the similarity between the text and the video.

Optionally, a weight corresponding to each element in each level is determined based on normalization of text features or video features corresponding to elements in the level. In an example, for each element in each level, a degree of matching between a feature of the element and a feature corresponding to an associated element at a previous level can be determined, and then normalization of degrees of matching between elements at a same level can be performed, to obtain a corresponding weight. In an example, based on normalization of text features corresponding to elements in a syntactic level analysis result, a weight corresponding to an i^{th} element located at a second level can be represented as

$${w}_{i}^{2} = \frac{exp ( {s}_{i}^{2} )}{{Σ}_{j ∈ [ 1 , \vert {H}^{2} \vert ]} exp ( {s}_{j}^{2} )} ,$$

where sᵢ²=match(e₁^{t1},mᵢ^{t2}) and mᵢ^{t2}=norm(eᵢ^{t2}+MLP₅(eᵢ^{t2})). |H²| can be used to represent a quantity of elements located at the second level of the syntactic level analysis results or a video level analysis result. Similarly, a weight corresponding to an i^{th} element located at a third level can be represented as

$${w}_{i}^{3} = \frac{exp ( {s}_{{δ}_{i}^{3}}^{2} + {s}_{i}^{3} )}{{Σ}_{j ∈ [ 1 , \vert {H}^{3} \vert ]} exp ( {s}_{{δ}_{i}^{3}}^{2} + {s}_{j}^{3} )} ,$$

where sᵢ³=match(m_{δ}_{ᵢ}_{³}^{t2}, eᵢ^{t3}). |H³| can be used to represent a quantity of elements located at the third level of the syntactic level analysis results or the video level analysis result. It can be understood that other normalization ways than softmax can alternatively be used. Similarly, a weight corresponding to each element in each level can alternatively be determined based on normalization of video features corresponding to elements in the video level analysis result.

Based on this, in this solution, appropriate weights can be allocated to elements (for example, in a text-video node pair) based on a syntactic level structure, so that different importance of different actions to entire text and different importance of different entities to a same action are fully reflected, thereby more conforming with objective logic of semantic understanding. Further, a purpose of aligning text-video features at different granularities is achieved by aggregating scores of similarities at a same level.

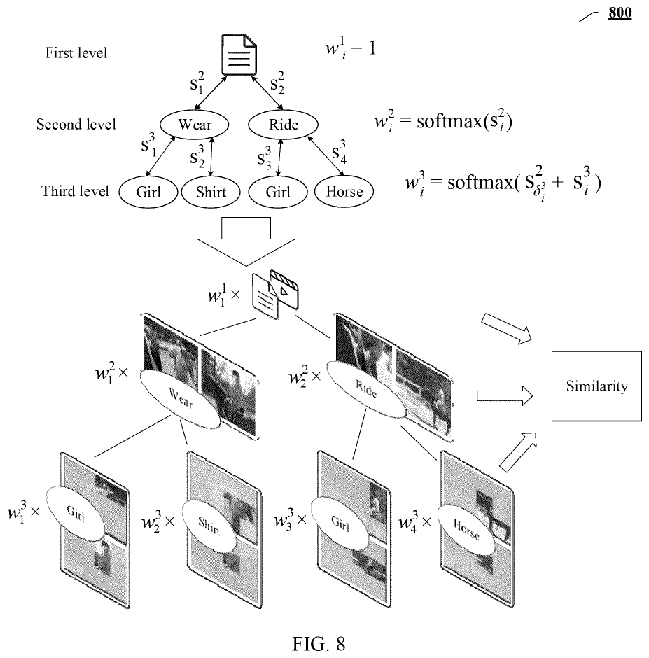

Refer to FIG. 8 below. FIG. 8 is an example diagram illustrating a determining process 800 of a similarity between text and a video, according to one or more embodiments of this specification.

As shown in FIG. 8, references can be made to the above-mentioned descriptions for determining a degree sⱼⁱ of matching between a feature of each element located at an i^{th} level and a feature corresponding to an associated element at a previous level can be determined, where j∈[1,|H′]. For example, for a second level, degrees s₁² and s₂² of matching between text features corresponding to “wear” and “ride” and an entire sentence “A young girl is wearing a green shirt and the girl is riding a horse” can be respectively determined. Afterwards, a softmax operation is performed on s₁² and s₂², to obtain weights w₁² and w₂² that respectively correspond to the action node representing “wear” and the action node representing “ride”. Similarly, weights w₁³, w₂³, w₃³ w₃⁴ that correspond to all entity nodes can be obtained by using the determined degrees s₁³, s₂³, s₃³ and s₄³ of matching.

In an example, weighted summation can be performed on similarities corresponding to elements located at a same level based on the weights, to obtain a similarity corresponding to each level. The similarity between the text and the video is then obtained by combining (for example, performing averaging on) similarities corresponding to all levels.

According to the methods, disclosed in FIG. 1 to FIG. 8, for determining a similarity between text and a video, text description can be highly abstracted by establishing a syntactic level structure, and a corresponding video level analysis result is obtained through guiding based on the established syntactic level structure, to further provide a basis for filtering and fusion of video features of different granularities, so that redundant information is filtered from the video at the different granularities and the video features are enhanced through feature fusion, thereby improving an interaction degree of information between the text and the video, and further improving an effect of the determined similarity between the text and the video.

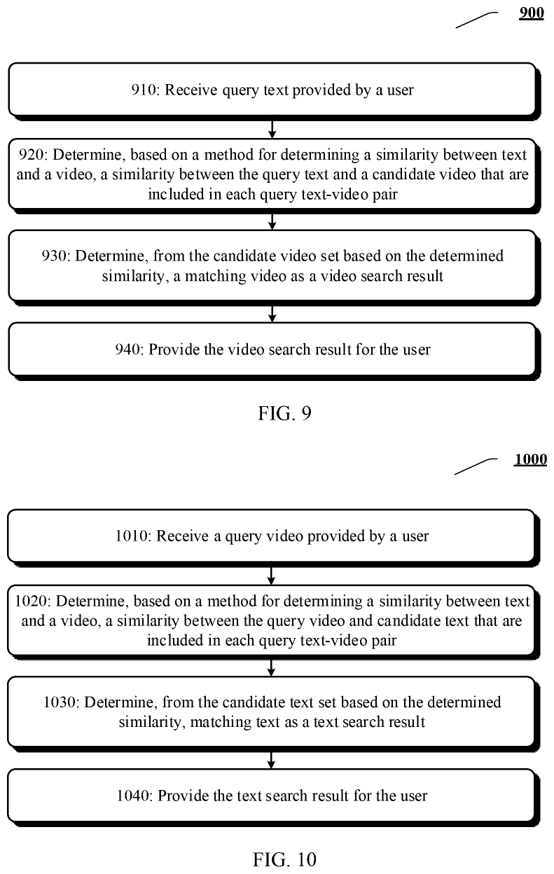

Refer to FIG. 9. FIG. 9 is an example flowchart illustrating a text-video retrieval method 900, according to one or more embodiments of this specification.

As shown in FIG. 9, in 910, query text provided by a user is received.

In this embodiment, the query text provided by the user can be received in various ways. For example, the query text can be text directly entered on a user terminal, or can be text obtained through conversion by performing optical character recognition (OCR) or automatic speech recognition (ASR) on an image, a video, a voice, etc. that are input by the user by using the user terminal. Implementations are not limited here.

In 920, a similarity between the query text and a candidate video that are included in each query text-video pair is determined based on a method for determining a similarity between text and a video.

In this embodiment, the query text can be combined with each candidate video in a candidate video set, to obtain each query text-video pair. Candidate videos included in the candidate video set can be provided based on actual needs, and for example, can be all candidate videos or can be some candidate videos recalled based on various coarse screening ways. For the above-mentioned method for determining a similarity between text and a video, reference can be specifically made to related descriptions of the embodiments of FIG. 1 to FIG. 8.

In 930, a matching video is determined, as a video search result, from the candidate video set based on the determined similarity.

In this embodiment, the matching video can be determined from the candidate video set in various ways For example, several candidate videos with a largest similarity can be determined as matching videos. For another example, candidate videos whose similarities are greater than a predetermined threshold can be used as candidate matching videos, and then several matching videos can be determined, as video search results, from the candidate matching videos in a random selection way, a selection way in accordance with a preference of the user, etc.

In 940, the video search results can be provided for a user.

In this embodiment, the video search results can be provided for the user in various forms. For example, the video search results can be arranged in order of similarity from largest to smallest in a list form. Optionally, corresponding similarities can alternatively be shown near the video search results.

It is worthwhile to note that, the user to whom the video search results are provided can be the same user as the user described in step 910 above or can be a user using the same user terminal as the user described in step 910 above. Implementations are not limited here.

Refer to FIG. 10. FIG. 10 is an example flowchart illustrating a video-text retrieval method 1000, according to one or more embodiments of this specification.

As shown in FIG. 10, in 1010, a query video provided by a user is received.

In 1020, a similarity between the query video and candidate text that are included in each query text-video pair is determined based on a method for determining a similarity between text and a video.

In this embodiment, each query text-video pair is obtained based on the query video and each piece of candidate text in a candidate text set.

In 1030, matching text is determined, as a text search result, from the candidate text set based on the determined similarity.

In 1040, the text search result is provided for a user.

It is worthwhile to note that, for specific descriptions of step 1010 to step 1040 above, references can be made to step 910 to step 940 of the above-mentioned embodiment of FIG. 9, provided that the query text is interchanged with the query video and the candidate video is interchanged with the candidate text.

According to the text-video retrieval method and the video-text retrieval method that are disclosed in FIG. 9 and FIG. 10, a method in which the method for determining a similarity between text and a video can be applied to the fields of text-video retrieval and video-text retrieval is provided, to more efficiently and accurately return a retrieval result.

Refer to FIG. 11. FIG. 11 is an example flowchart illustrating a method for training a feature extraction model 1100, according to one or more embodiments of this specification.

As shown in FIG. 11, in 1110, iterative execution is performed on the following model training process 1120 to 1160 by using a training sample set until a training end condition is satisfied.

In this embodiment, each training sample in the training sample set can include a positive example text-video pair including text data and video data that match each other or a negative example text-video pair including text data and video data that do not match each other. In an example, a piece of video data vᵢ and text data tᵢ used to describe the video data can constitute a positive example text-video pair (tᵢ, vᵢ); and a piece of video data vⱼ and text data tᵢ (i≠j) used to describe other video data can constitute a negative example text-video pair (tᵢ,vⱼ). The feature extraction model includes a text feature extraction model, a video feature extraction model, a text feature processing model, and a video feature processing model.

In 1120, text data of each current training sample in a current training sample set is provided for a current text feature extraction model, to obtain an initial text feature of each current training sample.

In this embodiment, the current training sample can be a batch of training samples selected from the training sample set in a current iteration process. A quantity of current training samples included in the current training sample set is equivalent to a predetermined batchsize.

In 1130, video data of each current training sample is provided for a current video feature extraction model, to obtain an initial video feature of each current training sample.

Step 1140 to step 1148 below are performed for each current training sample.

In 1140, syntactic analysis is performed on the text data of the current training sample, to obtain a corresponding syntactic level analysis result.

In 1142, the obtained syntactic level analysis result and the initial text feature are provided for a current text feature processing model, to obtain text features respectively corresponding to elements in the syntactic level analysis result.

In this embodiment, the current text feature processing model can be used to perform an operation of processing the initial text feature in the above-mentioned embodiment of FIG. 2. The text feature processing model can include various models with adjustable parameters for feature processing. In an example, for the adjustable parameters of the text feature processing model, references can be made to the descriptions of step 320 in the above-mentioned embodiment of FIG. 3.

In 1144, a video level analysis result corresponding to the syntactic level analysis result is constructed based on a degree of matching between the obtained text features respectively corresponding to the elements in the syntactic level analysis result and the obtained initial video feature.

In 1146, initial video features corresponding to elements in the video level analysis result are provided for a current video feature processing model based on the video level analysis result, to obtain video features respectively corresponding to the elements in the video level analysis result.

In this embodiment, the current video feature processing model can be used to perform an operation of processing the initial video feature in the above-mentioned embodiment of FIG. 2. The video feature processing model can include various models with adjustable parameters for feature processing. In an example, for the adjustable parameters of the video feature processing model, references can be made to corresponding descriptions in step 710 and the optional implementations of the above-mentioned embodiment of FIG. 7.

In 1148, a similarity between the text data of the current training sample and corresponding video data is determined based on a similarity between a text feature and a video feature that respectively correspond to elements in a corresponding level.

It is worthwhile to note that, for specific operation processes of step 1120, step 1130, and step 1140 to step 1148, reference can be respectively made to related descriptions of step 210 and step 220 to step 260 in the embodiment of FIG. 2. Details are omitted here.

In 1150, a contrastive loss value corresponding to the current training sample set is determined based on a determined similarity between the text data of each current training sample and corresponding video data.

In an example, at least one of a text-image contrastive loss value and an image-text contrastive loss value can be determined in accordance with a predetermined contrastive learning loss function based on the determined similarity between the text data of each current training sample and the corresponding video data. The text-image contrastive loss value can be represented, for example, as

$${ℒ}_{p}^{t 2 v} = - \frac{1}{B} {Σ}_{i = 1}^{B} log \frac{exp ( τ \cdot sim ( {t}_{i} , {v}_{i} ) )}{{Σ}_{j = 1}^{B} exp ( τ \cdot sim ( {t}_{i} , {v}_{j} ) )} .$$

Correspondingly, the image-text contrastive loss value can be represented, for example, as

$${ℒ}_{p}^{v 2 t} = - \frac{1}{B} {Σ}_{i = 1}^{B} log \frac{exp ( τ \cdot sim ( {t}_{i} , {v}_{i} ) )}{{Σ}_{j = 1}^{B} exp ( τ \cdot sim ( {t}_{j} , {v}_{i} ) )} .$$

B can be used to represent a batchsize, for example, a quantity of positive example text-video pairs. τ can be used to represent a temperature coefficient of the contrastive learning loss function. sim(tᵢ,vᵢ) can be used to represent a similarity between text data and corresponding video data in an i^{th} positive example text-video pair. Correspondingly, sim(tᵢ,vⱼ) and sim(tⱼ,vᵢ) can be used to represent a similarity between text data and corresponding video data in a negative example text-video pair.

In an example, the contrastive loss value corresponding to the current training sample set can be determined based on at least one of the text-to-image contrast loss value and the image-to-text contrast loss value, for example, one of the two or an average of the two.

In 1160, whether a training end condition is satisfied is determined.

In an example, whether the training end condition is satisfied can be determined by determining whether a quantity of times of iteration reaches a predetermined quantity of times, whether training duration reaches predetermined duration, whether a contrastive loss value converges, etc.

In 1170, a model parameter of a current feature extraction model is adjusted based on the contrastive loss value in response to dissatisfaction of the training end condition.

In this embodiment, the feature extraction model (including the text feature extraction model, the video feature extraction model, the text feature processing model, and the video feature processing model) after being adjusted by using the model parameter can be used as a current feature extraction model (including a current text feature extraction model, a current video feature extraction model, a current text feature processing model, and a current video feature processing model) for a next model training process. Afterwards, a current training sample set can be determined by using the above-mentioned training sample set, and the model training process 1120 to 1160 can still be performed until the training end condition is satisfied.

In response to satisfying the training end condition, the current feature extraction model is determined as a feature extraction model (including a text feature extraction model, a video feature extraction model, a text feature processing model, and a video feature processing model) for which training is completed. In this way, corresponding text features and video features can be obtained by using the text feature extraction model, the video feature extraction model, the text feature processing model, and the video feature processing model that are included in the feature extraction model for which training is completed, thereby determining a similarity between corresponding text and a video.

According to the method for training a feature extraction model disclosed in FIG. 11, the corresponding video level analysis result can be obtained through guiding by using the syntactic level structure established based on text analysis, and then the initial text features and the initial video features that are obtained through the text feature extraction model and the video feature extraction model can be processed through design of the text feature processing model and the video feature processing model, so that fusion of text features based on a text structure and screening and fusion of video features of different granularities are achieved, and cross-modality interaction between the text and the video under a feedback signal of a contrastive learning loss calculation way is fully learned, thereby enabling a feature extraction model obtained through training to generate a feature representation that can include a larger amount of information.

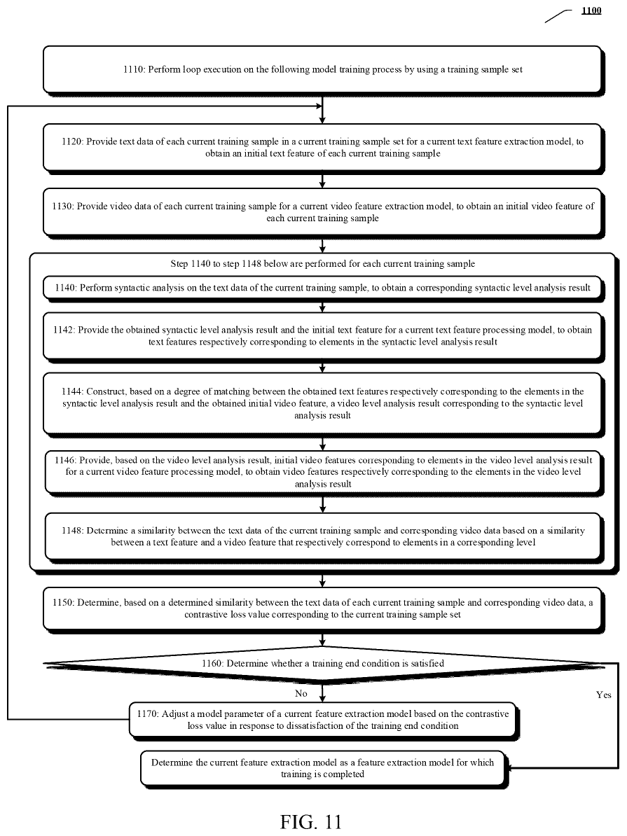

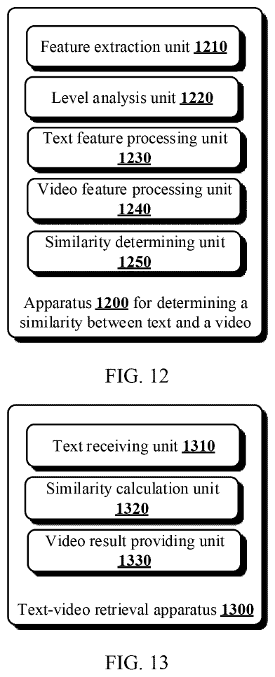

Refer to FIG. 12. FIG. 12 is an example block diagram illustrating an apparatus 1200 for determining a similarity between text and a video, according to one or more embodiments of this specification. The apparatus embodiment can correspond to the method embodiments shown in FIG. 2 to FIG. 8, and the apparatus can be specifically used in various electronic devices.

As shown in FIG. 12, the apparatus 1200 for determining a similarity between text and a video can include a feature extraction unit 1210, a level analysis unit 1220, a text feature processing unit 1230, a video feature processing unit 1240, and a similarity determining unit 1250.

The feature extraction unit 1210 is configured to respectively provide text and a video that are included in an acquired text-video pair for a text feature extraction model and a video feature extraction model, to obtain a corresponding initial text feature and a corresponding initial video feature, where the initial text feature includes word character features corresponding to word characters included in the text, and the initial video feature includes an image feature extracted based on an image included in the video. For operations of the feature extraction unit 1210, references can be made to the operation in 210 described in FIG. 2 above.

The level analysis unit 1220 is configured to perform syntactic analysis on the text, to obtain a syntactic level analysis result; and construct, based on a degree of matching between obtained text features respectively corresponding to elements in the syntactic level analysis result and the obtained initial video feature, a video level analysis result corresponding to the syntactic level analysis result. For operations of the level analysis unit 1220, references can be made to the operations in 220 and 240 described in FIG. 2 above.

In an example, for the operations of the level analysis unit 1220, references can be further made to the related descriptions of the embodiments of FIG. 4, FIG. 5, and FIG. 6. Details are omitted here.

The text feature processing unit 1230 is configured to process the initial text feature based on the syntactic level analysis result, to obtain the text features respectively corresponding to the elements in the syntactic level analysis result. For operations of the text feature processing unit 1230, references can be made to the operation in 230 described in FIG. 2 above.

In an example, for the operations of the text feature processing unit 1230, references can be further made to the operations in 310 and 320 described in FIG. 3 above. Details are omitted here.

The video feature processing unit 1240 is configured to respectively provide text and a video that are included in an acquired text-video pair for a text feature extraction model and a video feature extraction model, to obtain a corresponding initial text feature and a corresponding initial video feature, where the initial text feature includes word character features corresponding to word characters included in the text, and the initial video feature includes an image feature extracted based on an image included in the video. For operations of the video feature processing unit 1240, references can be made to the operation in 250 described in FIG. 2 above.

In an example, for the operations of the video feature processing unit 1240, references can be further made to the operations in 710 and 720 described in FIG. 7 and the optional implementations thereof. Details are omitted here.

The similarity determining unit 1250 is configured to determine a similarity between the text and the video based on a similarity between a text feature and a video feature that respectively correspond to elements in a corresponding level. For operations of the similarity determining unit 1250, references can be made to the operation in 260 described in FIG. 2 above.

In an example, for the operations of the similarity determining unit 1250, references can be further made to the related descriptions of the embodiment of FIG. 8. Details are omitted here.

Refer to FIG. 13. FIG. 13 is an example block diagram illustrating a text-video retrieval apparatus 1300, according to one or more embodiments of this specification. This apparatus embodiment can correspond to the method embodiment shown in FIG. 9, and the apparatus can be specifically used in various electronic devices.

As shown in FIG. 13, a text-video retrieval apparatus 1300 can include a text receiving unit 1310, a similarity calculation unit 1320, and a video result providing unit 1330.

The text receiving unit 1310 is configured to receive query text provided by a user. For operations of the text receiving unit 1310, references can be made to the operation in 910 described in FIG. 9 above.

The similarity calculation unit 1320 is configured to determine, based on the above-mentioned method for determining a similarity between text and a video, a similarity between the query text and a candidate video that are included in each query text-video pair, where each query text-video pair is obtained based on the query text and each candidate video in a candidate video set. For operations of the similarity calculation unit 1320, references can be made to the operation in 920 described in FIG. 9 above.

The video result providing unit 1330 is configured to determine, from the candidate video set based on the determined similarity, a matching video as a video search result; and provide the video search result for the user. For operations of the video result providing unit 1330, references can be made to the operations in 930 and 940 described in FIG. 9 above.

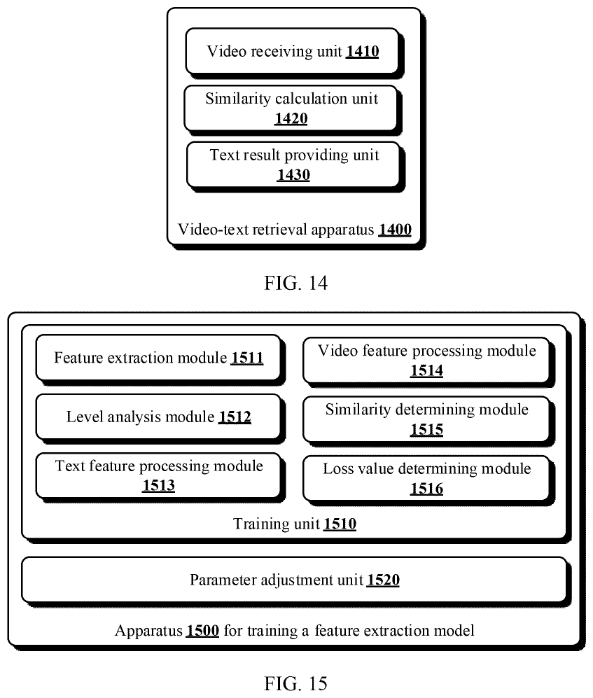

Refer to FIG. 14. FIG. 14 is an example block diagram illustrating a video-text retrieval apparatus 1400, according to one or more embodiments of this specification. This apparatus embodiment can correspond to the method embodiment shown in FIG. 10, and the apparatus can be specifically used in various electronic devices.

As shown in FIG. 14, the video-text retrieval apparatus 1400 can include a video receiving unit 1410, a similarity calculation unit 1420, and a text result providing unit 1430.

The video receiving unit 1410 is configured to receive a query video provided by a user. For operations of the video receiving unit 1410, references can be made to the operation in 1010 described in FIG. 10 above.

The similarity calculation unit 1420 is configured to determine, based on the above-mentioned method for determining a similarity between text and a video, a similarity between the query video and candidate text that are included in each query text-video pair, where each query text-video pair is obtained based on the query video and each piece of candidate text in a candidate text set. For operations of the similarity calculation unit 1420, references can be made to the operation in 1020 described in FIG. 10 above.

The text result providing unit 1430 is configured to determine, from the candidate text set based on the determined similarity, matching text as a text search result; and provide the text search result for the user. For operations of the text result providing unit 1430, references can be made to the operations in 1030 and 1040 described in FIG. 10 above.

Refer to FIG. 15. FIG. 15 is an example block diagram illustrating an apparatus 1500 for training a feature extraction model, according to one or more embodiments of this specification. This apparatus embodiment can correspond to the method embodiment shown in FIG. 11, and the apparatus can be specifically used in various electronic devices.

As shown in FIG. 15, the apparatus 1500 for training a feature extraction model can include a training unit 1510 and a parameter adjustment unit 1520. The feature extraction model includes a text feature extraction model, a video feature extraction model, a text feature processing model, and a video feature processing model. The apparatus 1500 for training a feature extraction model is configured to perform, through the training unit 1510 by using a training sample set, iterative execution on a model training process until a training end condition is satisfied. Each training sample in the training sample set includes a positive example text-video pair including text data and video data that match each other or a negative example text-video pair including text data and video data that do not match each other.

The training unit 1510 can include a feature extraction module 1511, a level analysis module 1512, a text feature processing module 1513, a video feature processing module 1514, a similarity determining module 1515, and a loss value determining module 1516.

The feature extraction module 1511 is configured to provide text data of each current training sample in a current training sample set for a current text feature extraction model, to obtain an initial text feature of each current training sample; and provide video data of each current training sample for a current video feature extraction model, to obtain an initial video feature of each current training sample.

The level analysis module 1512 is configured to perform syntactic analysis on the text data of each current training sample, to obtain a corresponding syntactic level analysis result; and construct, based on a degree of matching between obtained text features respectively corresponding to elements in the syntactic level analysis result and the obtained initial video feature, a video level analysis result corresponding to each syntactic level analysis result.

The text feature processing module 1513 is configured to provide the obtained syntactic level analysis result and the initial text feature for a current text feature processing model, to obtain text features respectively corresponding to elements in each syntactic level analysis result.

The video feature processing module 1514 is configured to provide, based on the video level analysis result, initial video features corresponding to elements in the video level analysis result for a current video feature processing model, to obtain video features respectively corresponding to elements in each video level analysis result.

The similarity determining module 1515 is configured to determine a similarity between the text data of each current training sample and corresponding video data based on a similarity between a text feature and a video feature that respectively correspond to elements in a corresponding level.

The loss value determining module 1516 is configured to determine, based on a determined similarity between the text data of each current training sample and corresponding video data, a contrastive loss value corresponding to the current training sample set.

It is worthwhile to note that, for operations of the feature extraction module 1511, the level analysis module 1512, the text feature processing module 1513, the video feature processing module 1514, the similarity determining module 1515, and the loss value determining module 1516, references can be made to the operations in 1120 and 1130, 1140 and 1144, 1142, 1146, 1148, and 1150 described in FIG. 11 above.

The parameter adjustment unit 1520 is configured to adjust a model parameter of a current feature extraction model based on the contrastive loss value in response to dissatisfaction of the training end condition, where the feature extraction model after being adjusted by using the model parameter is used as a current feature extraction model in a next model training process. For operations of the parameter adjustment unit 1520, references can be made to the operations in 1160 and 1170 described in FIG. 11 above.

In the above, with reference to FIG. 1 to FIG. 15, the embodiments of the method and the apparatus for determining a similarity between text and a video, the text-video retrieval method and apparatus, the video-text retrieval method and apparatus, and the method and the apparatus for training a feature extraction model according to one or more embodiments of this specification are described.

The apparatus for determining a similarity between text and a video, the text-video retrieval apparatus, the video-text retrieval apparatus, and the apparatus for training a feature extraction model according to one or more embodiments of this specification can be implemented by hardware or can be implemented by software or a combination of hardware and software. Software implementation is used as an example. As a logical apparatus, the apparatus is formed by reading a corresponding computer program instruction in a storage to a memory by a processor of a device in which the apparatus is located. In one or more embodiments of this specification, the apparatus for determining a similarity between text and a video, the text-video retrieval apparatus, the video-text retrieval apparatus, and the apparatus for training a feature extraction model can be implemented by an electronic device.

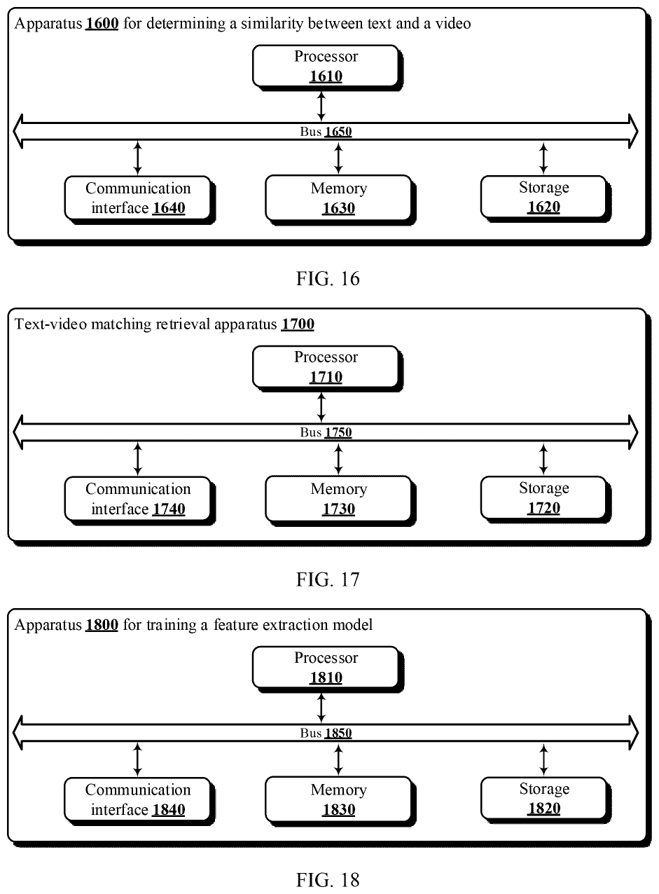

FIG. 16 is an example block diagram illustrating an apparatus 1600 for determining a similarity between text and a video, according to one or more embodiments of this specification.

As shown in FIG. 16, the apparatus 1600 for determining a similarity between text and a video can include at least one processor 1610, a storage (for example, a nonvolatile memory) 1620, a memory 1630, and a communication interface 1640, and the at least one processor 1610, the storage 1620, the memory 1630, and the communication interface 1640 are connected together through a bus 1650. The at least one processor 1610 executes at least one computer-readable instruction (to be specific, the above-mentioned element implemented in a software form) stored or encoded in the storage.

In one or more embodiments, a computer-executable instruction is stored in the storage. When the computer-executable instruction is executed, the at least one processor 1610 is enabled to perform the above-mentioned method for determining a similarity between text and a video.

It should be understood that when the computer-executable instruction stored in the memory is executed, the at least one processor 1610 is enabled to perform the various operations and functions described above with reference to FIG. 1 to FIG. 8 in the embodiments of this specification.

FIG. 17 is an example block diagram illustrating a text-video matching retrieval apparatus 1700, according to one or more embodiments of this specification.

As shown in FIG. 17, the text-video matching retrieval apparatus 1700 can include at least one processor 1710, a storage (for example, a nonvolatile memory) 1720, a memory 1730, and a communication interface 1740, and the at least one processor 1710, the storage 1720, the memory 1730, and the communication interface 1740 are connected together through a bus 1750. The at least one processor 1710 executes at least one computer-readable instruction (to be specific, the above-mentioned element implemented in a software form) stored or encoded in the storage.

In one or more embodiments, a computer-executable instruction is stored in the storage. When the computer-executable instruction is executed, the at least one processor 1710 is enabled to execute the above-mentioned text-video retrieval method or video-text retrieval method.

It should be understood that, when the computer-executable instruction stored in the storage is executed, the at least one processor 1710 is enabled to perform the above-mentioned operations and functions described with reference to FIG. 9 and FIG. 10 in the embodiments of this specification.

FIG. 18 is an example block diagram illustrating an apparatus 1800 for training a feature extraction model, according to one or more embodiments of this specification.

As shown in FIG. 18, the apparatus 1800 for training a feature extraction model can include at least one processor 1810, a storage (for example, a nonvolatile memory) 1820, a memory 1830, and a communication interface 1840, and the at least one processor 1810, the storage 1820, the memory 1830, and the communication interface 1840 are connected together through a bus 1850. The at least one processor 1810 executes at least one computer-readable instruction (to be specific, the above-mentioned element implemented in a software form) stored or encoded in the storage.

In one or more embodiments, a computer-executable instruction is stored in the storage. When the computer-executable instruction is executed, the at least one processor 1810 is enabled to perform the above-mentioned method for training a feature extraction model.

It should be understood that, when executed, the computer-executable instruction stored in the storage enables the at least one processor 1810 to perform the above-mentioned operations and functions described with reference to FIG. 11 in the embodiments of this specification.

According to one or more embodiments, a program product such as a computer-readable medium is provided. The computer-readable medium can have an instruction (to be specific, the above-mentioned element implemented in a software form). When the instruction is executed by a computer, the computer is enabled to perform the above-mentioned operations and functions described with reference to FIG. 1 to FIG. 11 in the embodiments of this specification.

Specifically, a system or an apparatus equipped with a readable storage medium can be provided, and software program code for implementing the functions in any of the above-mentioned embodiments is stored in the readable storage medium, so that a computer or a processor of the system or the apparatus reads and executes the instructions stored in the readable storage medium.

In this case, the program code read from the readable medium can implement the functions in any one of some embodiments described above, and therefore the machine-readable code and the readable storage medium storing the machine-readable code form a part of this application.

Computer program code needed for operation of each part of this specification can be compiled in any one or more programming languages, including an object-oriented programming language such as Java, Scala, Smalltalk, Eiffel, JADE, Emerald, C++, C#, VB, NET, and Python, a conventional programming language such as C language, Visual Basic 2003, Perl, COBOL 2002, PHP, and ABAP, a dynamic programming language such as Python, Ruby, and Groovy, or another programming language. The program code can run on a user computer, or run as a stand-alone software package on the user computer, or partially run on the user computer and partially run on a remote computer, or completely run on the remote computer or a server. In the latter case, the remote computer can be connected to the user computer in any form of network, such as a local area network (LAN) or a wide area network (WAN), or connected to an external computer (for example, via the Internet), or in a cloud computing environment, or used as a service, such as software as a service (Saas).

Embodiments of the readable storage medium include a floppy disk, a hard disk, a magneto-optical disk, an optical disc (such as a CD-ROM, a CD-R, a CD-RW, a DVD-ROM, a DVD-RAM, a DVD-RW, a DVD-RW), a magnetic tape, a non-volatile memory card, and a ROM. Alternatively, the program code can be downloaded from a server computer or a cloud by a communication network.

Specific embodiments of this specification are described above. Other embodiments fall within the scope of the appended claims. In some cases, the actions or steps described in the claims can be performed in an order different from those in the embodiments, and the desired results can still be achieved. In addition, processes described in the accompanying drawings do not necessarily need a specific order or a sequential order shown to achieve the desired results. In some implementations, multi-tasking and concurrent processing are feasible or may be advantageous.

Not all steps and units in the above-mentioned procedures and system structure diagrams are necessary. Some steps or units can be ignored based on actual needs. An execution order of the steps is not fixed, and can be determined based on a need. The apparatus structure described in the above-mentioned embodiments can be a physical structure, or can be a logical structure. In other words, some units can be implemented by the same physical entity, or some units can be implemented by multiple physical entities or implemented jointly by some components in multiple independent devices.

The term “example” used throughout this specification means “used as an example, an instance, or an illustration” and does not mean “preferred” or “advantageous” over other embodiments. Specific implementations include specific details for the purpose of providing an understanding of the described technologies. However, these technologies can be implemented without these specific details. In some instances, to avoid obscuring the described concepts in the embodiments, well-known structures and apparatuses are shown in the form of a block diagram.

Optional implementations of the embodiments of this specification are described above with reference to the accompanying drawings. However, the embodiments of this specification are not limited to specific details in the above-mentioned implementations. Within a technical concept scope of the embodiments of this specification, multiple simple variations of the technical solutions of the embodiments of this specification can be made, and these simple variations are all within the protection scope of the embodiments of this specification.

The above-mentioned descriptions of content in this specification are provided to enable any person of ordinary skill in the art to implement or use content in this specification. It is obvious to a person of ordinary skill in the art that various modifications can be made to the content in this specification. In addition, the general principle defined in this specification can be applied to another variant without departing from the protection scope of the in this specification. Therefore, the content in this specification is not limited to the examples and designs described here, but is consistent with the widest range of principles and novelty features that conform to this disclosure.

1-21. (canceled)

22. A computer-implemented method for determining a similarity between text and a video, comprising:
respectively providing text and a video that are comprised in an acquired text-video pair for a text feature extraction model and a video feature extraction model, to obtain a corresponding initial text feature and a corresponding initial video feature, wherein the initial text feature comprises word character features corresponding to word characters comprised in the text, and the initial video feature comprises an image feature extracted based on an image comprised in the video;
performing syntactic analysis on the text, to obtain a syntactic level analysis result;
processing the initial text feature based on the syntactic level analysis result, to obtain text features respectively corresponding to elements in the syntactic level analysis result;
constructing, based on a degree of matching between the text features respectively corresponding to the elements in the syntactic level analysis result and the initial video feature, a video level analysis result corresponding to the syntactic level analysis result;
processing, based on the video level analysis result, initial video features corresponding to elements in the video level analysis result, to obtain video features respectively corresponding to the elements in the video level analysis result; and
determining a similarity between the text and the video based on a similarity between a text feature and a video feature that respectively correspond to elements in a corresponding level.

23. The computer-implemented method according to claim 22, wherein the elements in the syntactic level analysis result comprise a sentence node located at a first level and an action node located at a second level; and
the elements in the video level analysis result comprise a video node located at a first level and a frame node located at a second level, wherein the frame node corresponds to a video frame group, and each video frame in the video frame group matches the action node.

24. The computer-implemented method according to claim 23, wherein the elements in the syntactic level analysis result further comprise an entity node located at a third level; and
the elements in the video level analysis result further comprise an image patch node located at a third level, wherein the image patch node corresponds to an image patch group, and each image patch in the image patch group matches the entity node and belongs to a video frame in a corresponding video frame group.

25. The computer-implemented method according to claim 24, wherein the elements in the syntactic level analysis result further comprise an attribute node located at a fourth level; and
the processing the initial text feature based on the syntactic level analysis result, to obtain text features respectively corresponding to elements in the syntactic level analysis result comprises:
respectively extracting, from the initial text feature, initial text features corresponding to the elements in the syntactic level analysis result, to obtain text features corresponding to the sentence node and the action node; and
for each entity node, performing, based on an initial text feature corresponding to an attribute node associated with the entity node, feature enhancement on an initial text feature corresponding to the entity node, to obtain a text feature corresponding to each entity node.

26. The computer-implemented method according to claim 23, wherein the initial video feature comprises a frame feature corresponding to a video frame; and
the constructing, based on a degree of matching between the text features respectively corresponding to the elements in the syntactic level analysis result and the initial video feature, a video level analysis result corresponding to the syntactic level analysis result comprises:
providing, for a time encoding model, an obtained frame feature corresponding to a video frame, to obtain a time encoding feature that fuses with time information and that corresponds to each frame feature; and
for each action node,
determining a degree of matching between a text feature corresponding to the action node and each time encoding feature; and
selecting a 1^{st} quantity of video frames corresponding to time encoding features whose degrees of matching satisfy a first predetermined need, to constitute the video frame group, to obtain a frame node that is located at the second level and that corresponds to the action node.

27. The computer-implemented method according to claim 24, wherein the initial video feature comprises an image patch feature corresponding to an image patch obtained through division of the video frame; and
the constructing, based on a degree of matching between the text features respectively corresponding to the elements in the syntactic level analysis result and the initial video feature, a video level analysis result corresponding to the syntactic level analysis result comprises:
for each frame node,
determining a degree of matching between a text feature corresponding to an entity node corresponding to the frame node and an image patch feature corresponding to an image patch obtained through division of each video frame in a video frame group corresponding to the frame node; and
selecting a 2^{nd} quantity of image patches corresponding to image patch features whose degrees of matching satisfy a second predetermined need, to constitute an image patch group, to obtain an image patch node that is located at the third level and that is connected to the frame node.

28. The computer-implemented method according to claim 23, wherein the initial video feature comprises a frame feature corresponding to a video frame; and
the processing, based on the video level analysis result, initial video features corresponding to elements in the video level analysis result, to obtain video features respectively corresponding to the elements in the video level analysis result comprises:
determining, based on a degree of matching between frame features corresponding to video frames and a text feature corresponding to the sentence node, fusion coefficients corresponding to the frame features; and
fusing the frame features based on the fusion coefficients, to obtain a video feature corresponding to the video node.

29. The computer-implemented method according to claim 26, wherein the processing, based on the video level analysis result, initial video features corresponding to elements in the video level analysis result, to obtain video features respectively corresponding to the elements in the video level analysis result comprises:
for each frame node, fusing time encoding features corresponding to video frames in a video frame group corresponding to the frame node, to obtain a video feature corresponding to the frame node.

30. The computer-implemented method according to claim 27, wherein the processing, based on the video level analysis result, initial video features corresponding to elements in the video level analysis result, to obtain video features respectively corresponding to the elements in the video level analysis result comprises:
for each image patch node, fusing image patch features corresponding to image patches in an image patch group corresponding to the image patch node, to obtain a video feature corresponding to the image patch node.

31. The computer-implemented method according to claim 22, wherein the determining a similarity between the text and the video based on a similarity between a text feature and a video feature that respectively correspond to elements in a corresponding level comprises:
determining the similarity between the text and the video by performing weighted summation on a similarity between text features and video features that respectively correspond to elements in all levels.

32. The computer-implemented method according to claim 31, wherein a weight corresponding to each element in each level is determined based on normalization of text features or video features corresponding to elements in the level.

33. The computer-implemented method according to claim 32, comprising:
receiving query text provided by a user;
determining a query similarity between the query text and a candidate video comprised in each query text-video pair, wherein the each query text-video pair is obtained based on the query text and each candidate video in a candidate video set;
determining, from the candidate video set based on the query similarity, a matching video as a video search result; and
providing the video search result for the user.

34. The computer-implemented method according to claim 32, comprising:
receiving a query video provided by a user;
determining a query similarity between the query video and candidate text comprised in each query text-video pair, wherein the each query text-video pair is obtained based on the query video and each piece of candidate text in a candidate text set;
determining, from the candidate text set based on the query similarity, matching text as a text search result; and
providing the text search result for the user.

35. A computer-implemented system comprising:
one or more processors; and
one or more tangible, non-transitory, machine-readable media storing one or more instructions that, when executed by the one or more processors, perform operations comprising:
respectively providing text and a video that are comprised in an acquired text-video pair for a text feature extraction model and a video feature extraction model, to obtain a corresponding initial text feature and a corresponding initial video feature, wherein the initial text feature comprises word character features corresponding to word characters comprised in the text, and the initial video feature comprises an image feature extracted based on an image comprised in the video;
performing syntactic analysis on the text, to obtain a syntactic level analysis result;
processing the initial text feature based on the syntactic level analysis result, to obtain text features respectively corresponding to elements in the syntactic level analysis result;
constructing, based on a degree of matching between the text features respectively corresponding to the elements in the syntactic level analysis result and the initial video feature, a video level analysis result corresponding to the syntactic level analysis result;
processing, based on the video level analysis result, initial video features corresponding to elements in the video level analysis result, to obtain video features respectively corresponding to the elements in the video level analysis result; and
determining a similarity between the text and the video based on a similarity between a text feature and a video feature that respectively correspond to elements in a corresponding level.

36. The computer-implemented system according to claim 35, wherein the elements in the syntactic level analysis result comprise a sentence node located at a first level and an action node located at a second level; and
the elements in the video level analysis result comprise a video node located at a first level and a frame node located at a second level, wherein the frame node corresponds to a video frame group, and each video frame in the video frame group matches the action node.

37. The computer-implemented system according to claim 36, wherein the elements in the syntactic level analysis result further comprise an entity node located at a third level; and
the elements in the video level analysis result further comprise an image patch node located at a third level, wherein the image patch node corresponds to an image patch group, and each image patch in the image patch group matches the entity node and belongs to a video frame in a corresponding video frame group.

38. The computer-implemented system according to claim 36, wherein the initial video feature comprises a frame feature corresponding to a video frame; and
the constructing, based on a degree of matching between the text features respectively corresponding to the elements in the syntactic level analysis result and the initial video feature, a video level analysis result corresponding to the syntactic level analysis result comprises:
providing, for a time encoding model, an obtained frame feature corresponding to a video frame, to obtain a time encoding feature that fuses with time information and that corresponds to each frame feature; and
for each action node,
determining a degree of matching between a text feature corresponding to the action node and each time encoding feature; and
selecting a 1^{st} quantity of video frames corresponding to time encoding features whose degrees of matching satisfy a first predetermined need, to constitute the video frame group, to obtain a frame node that is located at the second level and that corresponds to the action node.

39. A non-transitory, computer-readable medium storing one or more instructions executable by a computer system to perform operations comprising:
respectively providing text and a video that are comprised in an acquired text-video pair for a text feature extraction model and a video feature extraction model, to obtain a corresponding initial text feature and a corresponding initial video feature, wherein the initial text feature comprises word character features corresponding to word characters comprised in the text, and the initial video feature comprises an image feature extracted based on an image comprised in the video;
performing syntactic analysis on the text, to obtain a syntactic level analysis result;
processing the initial text feature based on the syntactic level analysis result, to obtain text features respectively corresponding to elements in the syntactic level analysis result;
constructing, based on a degree of matching between the text features respectively corresponding to the elements in the syntactic level analysis result and the initial video feature, a video level analysis result corresponding to the syntactic level analysis result;
processing, based on the video level analysis result, initial video features corresponding to elements in the video level analysis result, to obtain video features respectively corresponding to the elements in the video level analysis result; and
determining a similarity between the text and the video based on a similarity between a text feature and a video feature that respectively correspond to elements in a corresponding level.

40. The non-transitory, computer-readable medium according to claim 39, wherein the elements in the syntactic level analysis result comprise a sentence node located at a first level and an action node located at a second level; and
the elements in the video level analysis result comprise a video node located at a first level and a frame node located at a second level, wherein the frame node corresponds to a video frame group, and each video frame in the video frame group matches the action node.

41. The non-transitory, computer-readable medium according to claim 39, wherein the determining a similarity between the text and the video based on a similarity between a text feature and a video feature that respectively correspond to elements in a corresponding level comprises:
determining the similarity between the text and the video by performing weighted summation on a similarity between text features and video features that respectively correspond to elements in all levels.
